(19) United States
(12) Patent Application Publication
(10) Pub. No.: US 2004/0002886 A1
(43) Pub. Date: Jan. 1, 2004

(54) System and method for processing a service order

(76) Inventors: William M. Dickerson, Lawrenceville, GA (US); Kraig Thomas McCleery, Acworth, GA (US)

Correspondence Address: SHAW PITTMAN, IP GROUP, 1650 TYSONS BOULEVARD, SUITE 1300, MCLEAN, VA, 22102, US

(21) Appl. No.: 10/180,495

(22) Filed: Jun. 27, 2002

(51) Int. Cl. G06F 17/60; H04K 1/00

(52) U.S. Cl. 705/9

(57) ABSTRACT

A method and system for processing a service order includes a first database and a second database. Upon receiving a service order, the system stores the service order in the first database and examines it for a redundancy. If the service order is not a duplicate service, the system formats the service order into a user friendly format and stores the formatted service order in the second database so that the service order can be displayed with a web GUI (graphic user interface). If the service order is a duplicate service order, the system deletes the duplicate service order and then formats the service order into a user friendly format and stores the formatted service order in the second database. The formatted service order is stored in the second database.

The present invention relates generally to business management, and more particularly to a method and system for processing a service order.

### BACKGROUND OF THE INVENTION

Generally, when a customer places a service order, the service order is received by a communication system, acting as a queue, in a service provider. Thereafter, the service order is forwarded to a support center where the service order is printed and manually distributed to technician who carries out the service order.

For example, when a telecommunications company such as Bell South receives a service order, such as a service order for a long distance service or for Internet service, the service order is received by a communication system, such as Bell South's SOCS (Service Order Communication System). The SOCS forwards the service order to a printer in BNISC (Broadband Network Infrastructure Support Center) via QMS (Queue Management Services)/BOSIP (BellSouth Open System Interconnect Platform). In BNISC, the printer prints the service order in its raw data form. The printed service order is manually organized and distributed to a technician. A copy of the printed service order is stored in a storage space.

This approach has a high probability of the human errors and results in a high cost since the process is manually performed. Additionally, since the service order is presented in its raw data form, it is not easy to understand for an untrained technician. Further, a communication system forwards all of the service orders, including duplicate orders, to a printer and technicians in support center, causing waste of the resources. Moreover, since the service orders are printed and filed, the service orders are hard to search and a storage space is needed. Thus, there is a need to provide improved methods and systems for processing an order.

### SUMMARY OF THE INVENTION

The present invention is related to a system and method for processing a service order.

In an embodiment of the present invention, a method and system for processing a service order includes a first database and a second database. Upon receiving a service order, the system stores the service order in the first database and examines it for a redundancy. If the service order is a duplicate service order, the system deletes the service order from the first database and the process ends. If the service order is not a duplication service order, the system then formats the service order into a user-friendly format and stores the formatted service order in the second database so that the service order can be displayed with a web GUI (graphic user interface).

In another embodiment of the present invention, a method and system for processing a service order receives the service order and stores the service order in a first database. The system examines the first database for redundancies. If there are duplicate service orders in the first database, the system deletes the duplicate service orders and then formats the service orders in the first database into a user-friendly format. The formatted service orders are stored in a second database.

### BRIEF DESCRIPTION OF THE DRAWINGS

FIG. 1 is a schematic diagram of a system according to a preferred embodiment of the present invention.

FIG. 2 is a flow diagram of a method according to a preferred embodiment of the present invention.

FIG. 3 is a flow diagram of a method according to another embodiment of the present invention.

FIG. 4 is an exemplary service order according to a preferred embodiment of the present invention.

FIG. 5 is an exemplary search window according to a preferred embodiment of the present invention.

FIG. 6 is an exemplary search result according to a preferred embodiment of the present invention.

### DETAILED DESCRIPTION OF THE INVENTION

Reference will now be made in detail to the preferred embodiments of the present invention, examples of which are illustrated in the accompanying drawings.

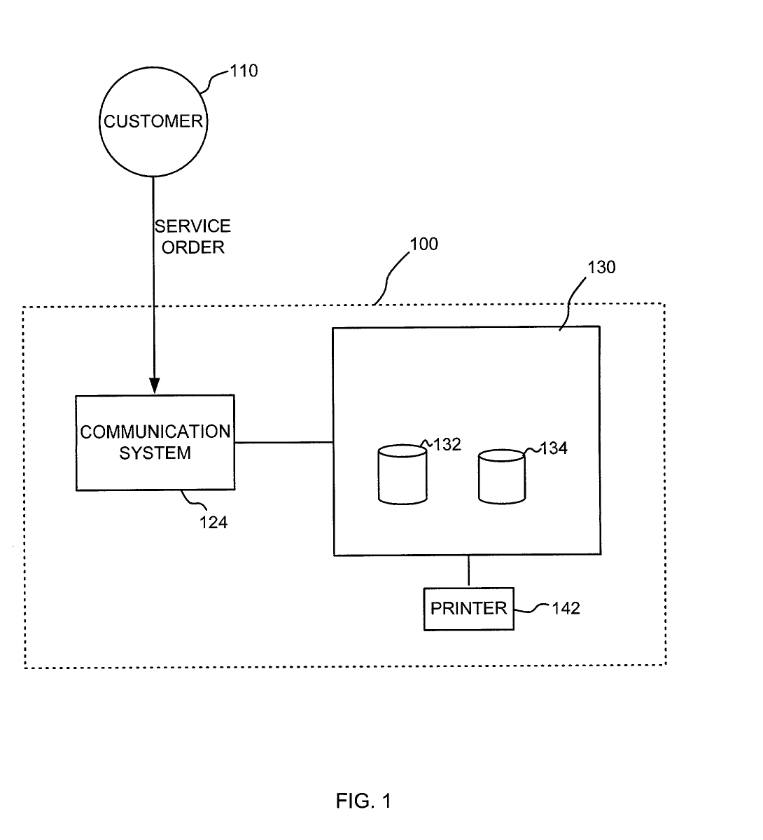

FIG. 1 shows a schematic diagram of a system according to a preferred embodiment of the present invention. As shown, service provider 100 includes a communication system 124 and a system 130. System 130 includes a first database 132 and a second database 134. When a customer 110 places a service order, communication system 124 (such as SOCS) receives the service order and forwards to system 130. System 130 receives the service order from communication system 124 and stores the service order in first database 132. System 130 examines service orders in first database 132 for redundancies. If there are duplicate service orders in first database 132, system 130 deletes the duplicate service orders. System 130 then formats the service orders in first database 132 to format the service orders into a user-friendly format and stores the formatted service orders in second database 134.

First database 132 and second database 134 can be in any format. For example, databases 132 and 134 can be an oracle database, object-oriented database, web-based database, or text database. Preferably, second database 134 is a searchable web-based database.

Printer 142 can be connected to system 130 to print the service orders. Printer 124 can print the service orders from either or both of first database 132 and second database 134. Further, system 130 can include any number of databases.

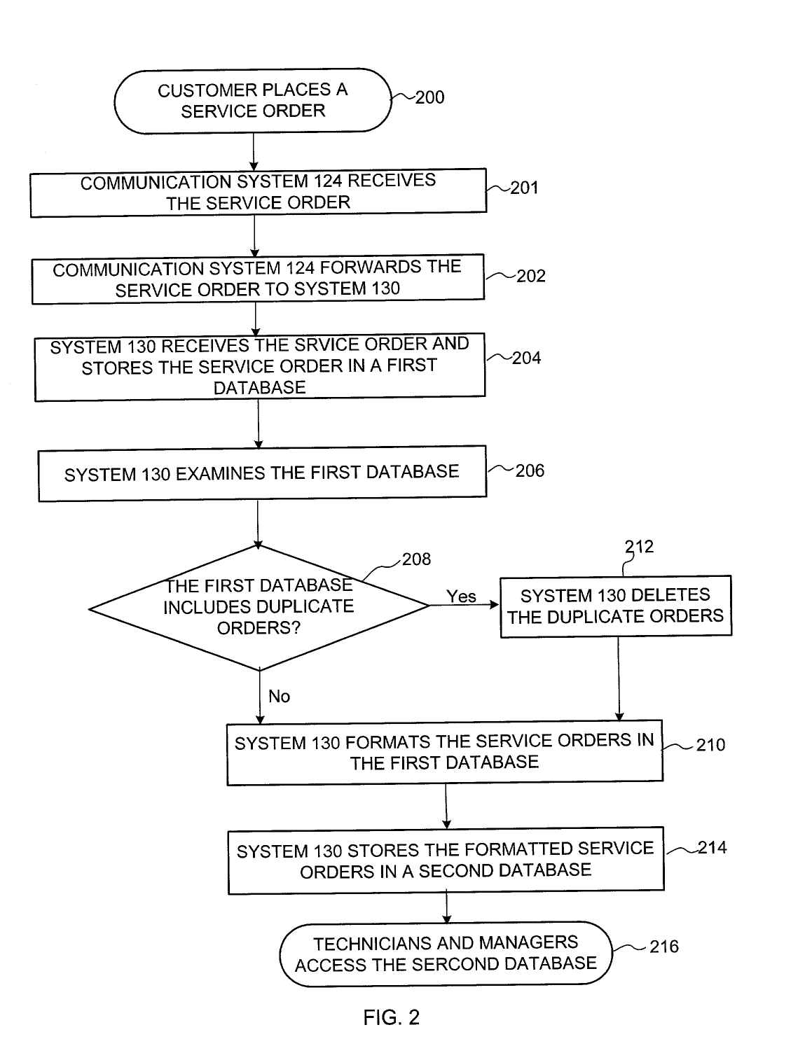

FIG. 2 shows a flow diagram of a method of processing a service order according to a preferred embodiment of the present invention. In step 200, a customer places a service order. In step 201, communication system 124 in service provider 100 receives the service order. An example of communication system 124 is Bell south's SOCS. In step 202, communication system 124 forwards the service order to system 130. In step 204, system 130 receives the service order from communication system 124 and stores the service order in first database 132. Preferably, first database 132 is UNIX based database. The process repeats steps 200 to 204 for each service order service provider 100 receives.

Thereafter, in step 206, system 130 examines first database 132 for redundancies. In step 208, system 130 determines if there are duplicate service orders in first database 132. If there are no duplicate service orders, the process proceeds to step 210. If there are duplicate service orders, system 130 deletes the duplicate service orders from first database 132 in step 212 and the process proceeds to step 210. System 130 can also rearrange the service orders in first database 132 if needed. For example, the service orders can be sorted by due date or customer name or according to another parameter.

In step 210, system 130 formats the service orders in first database 132. The service orders are formatted into a format that is easy to understand, even for untrained technicians. Preferably, the service orders are formatted so that the service orders can be displayed with a web GUI (graphic user interface), such as a web browser. JAVA script, for example, can be used to format the service orders in first database 132. In step 214, system 130 stores the formatted service orders in second database 134. Preferably, second database 134 is a searchable web-based database. Now, the service orders are in a form that is easy to understand and in step 216, technicians and managers can access the service orders by accessing second database 134 via web GUI, such as a web browser, or via a database management program, such as Microsoft Access. The service orders can also be printed if needed.

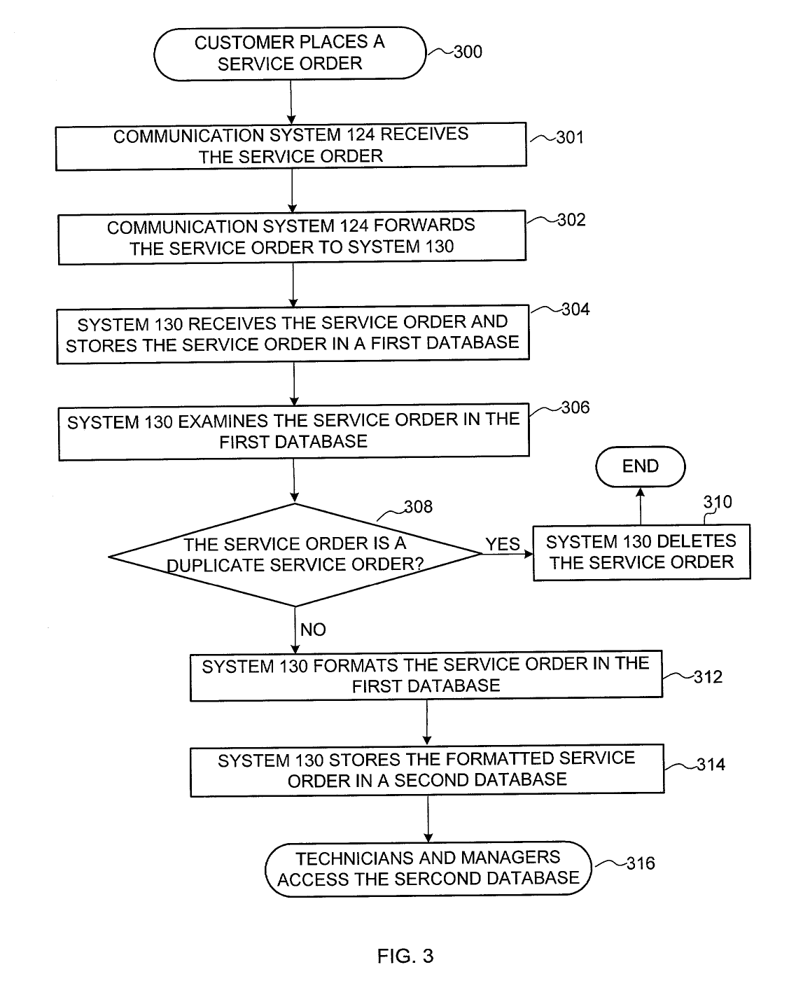

FIG. 3 shows a flow diagram of a method of processing a service order according to another embodiment of the present invention. In step 300, a customer places a service order. In step 301, communication system 124 in service provider 100 receives a service order from a customer. In step 302, communication system 124 forwards the service order to system 130. In step 304, system 130 receives the service order from communication system 124 and stores the service order in first database 132. In step 306, system 130 examines the service order in the first database for a redundancy. In step 308, system 130 determines if the service order is a duplicate service order. If the service order is a duplicate service order, system 130 deletes the service order from first database 132 in step 310 and the process ends.

If the service order is not a duplicate service order, system 130 formats the service order in first database 132 in step 312. The service order is formatted into a format that is easy to understand, even for untrained technicians. Preferably, the service order is formatted so that the service order can be displayed with a web GUI (graphic user interface), such as a web browser. In step 314, system 130 stores the formatted service order in second database 134. Now, the service order is in a form that is easy to understand and in step 134, technicians and managers can access the service order. The service order can also be printed if needed. The process repeats steps 300 to 314 for each service order service provider 100 receives.

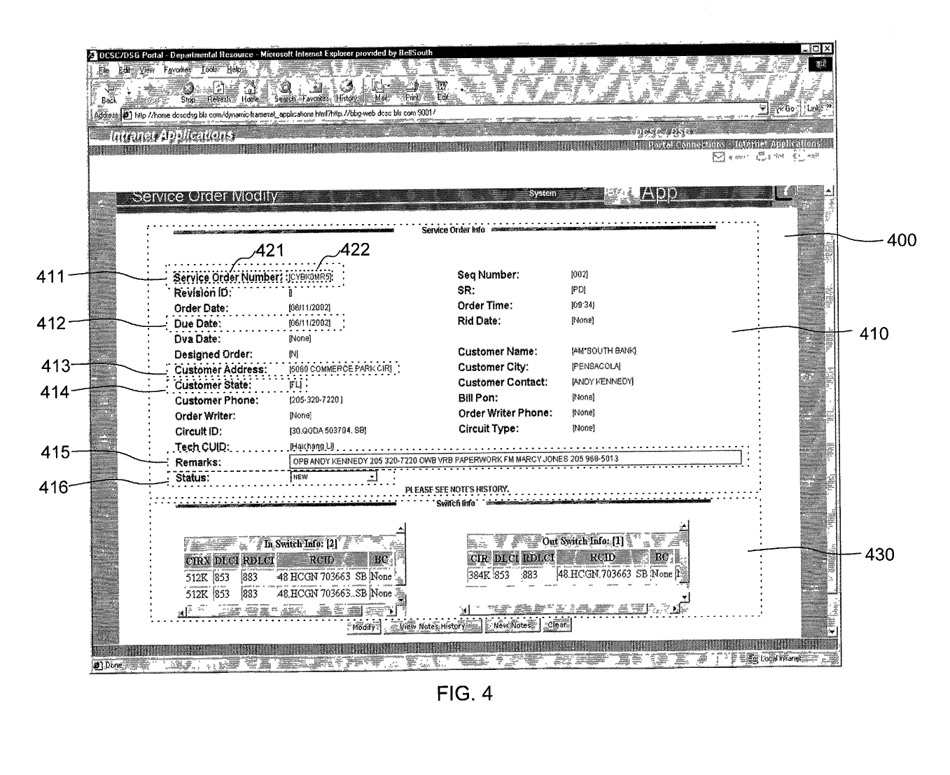

FIG. 4 shows an example of a service order displayed with a web browser according to a preferred embodiment of the present invention. As shown, service order 400 includes a service order info section 410 and a secondary info section 430. Service order info section 410 includes information regarding the service order. For example, service order info section 410 includes a service order number field 411, a due date field 412, a customer address field 413, and a customer state field 414. Each of the fields in service order info section 410 includes a field identifier and a field item. For example, service order number field 411 includes a field identifier 421 and a field item 422. Service order info section 410 also includes a remarks field 415 for adding comments and a status field 416 displaying the status of the service order, such as whether it is pending or completed. Secondary info section 430 can include any of the miscellaneous information related to the service order. For example, secondary info section 430 includes switch information.

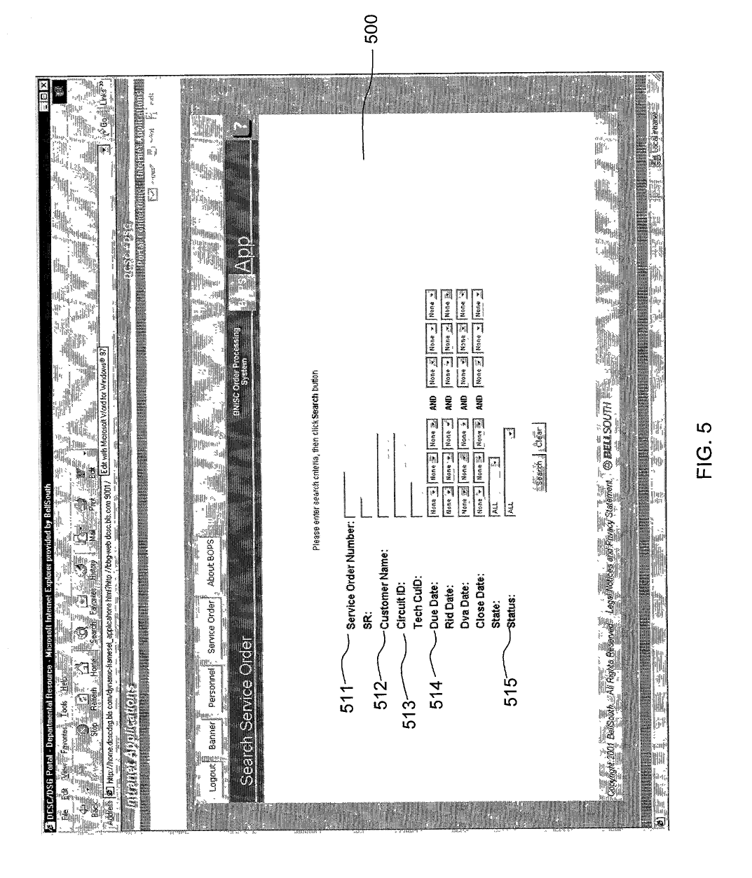

FIG. 5 shows an exemplary search options. For example, service orders can be searched with a service order number 511, a customer name 512, a circuit ID 513, a due data 514, and/or a status 515.

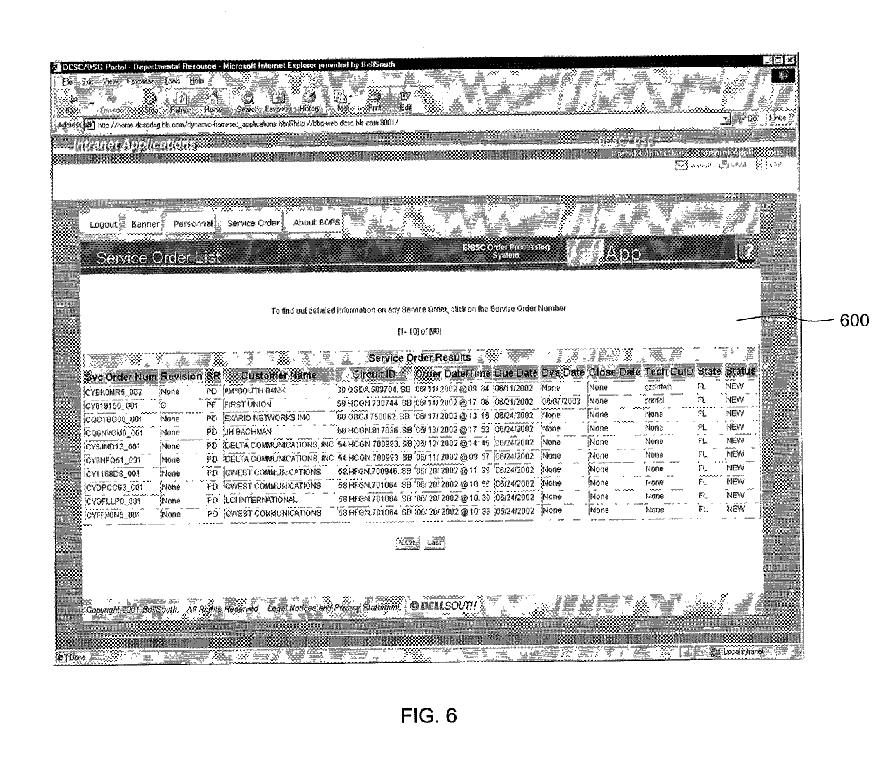

FIG. 6 shows an example of a service order list resulted by the search. The detailed information regarding a specific service order in a service order list 600 can be viewed by selecting the specific service order in the list.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is

1. A method for processing a service order comprising the steps of:
receiving the service order;
storing the service order in a first database;
formatting the service order in the first database into a web-viewable format; and
storing the formatted service order in a second database.

2. The method of claim 1, further comprising examining the service order in the first database for a redundancy.

3. The method of claim 1, further comprising examining the first database.

4. The method of claim 3, further comprising deleting duplicate service orders from the first database.

5. The method of claim 1, wherein the formatted service order includes a remark field.

6. The method of claim 1, wherein the formatted service order includes a status field.

7. The method of claim 1, wherein the second database is a web-based database.

8. The method of claim 1, wherein the second database is a searchable database.

9. The method of claim 1, wherein the formatted service order is displayed with a web browser.

10. A method for processing a service order comprising the steps of:
receiving the service order;
storing the service order in a first database;
examining the first database;
deleting a duplicate service order in the first database;
formatting the service order in the first database;
storing the formatted service order in a second database; and
accessing the formatted service order in the second database.

11. The method of claim 10, wherein a web GUI (graphic user interface) is used to access the formatted service order in the second database.

12. The method of claim 10, wherein the second database is a searchable web-based database.

13. The method of claim 10, wherein the formatted service order includes a remark field.

14. The method of claim 10, wherein the formatted service order includes a status field.

15. A method for processing a service order comprising the steps of:
receiving the service order;
storing the service order in a first database;
examining the service order in the first database; and
deleting the service order if the service order is a duplicate service order.

16. A system for processing a service order comprising:
means for receiving the service order;
means for storing the service order in a first database;
means for formatting the service order in the first database into a web-viewable format; and
means for storing the formatted service order in a second database.

17. The system of claim 16, further comprising means for examining the service order in the first database for a redundancy.

18. The system of claim 16, further comprising means for examining the first database.

19. The system of claim 18, further comprising means for deleting duplicate service orders from the first database.

20. The system of claim 16, wherein the formatted service order includes a remark field.

21. The system of claim 16, wherein the formatted service order includes a status field.

22. The system of claim 16, wherein the second database is a web-based database.

23. The system of claim 16, wherein the second database is a searchable database.

24. The system of claim 16, wherein the formatted service order is displayed with a web GUI (graphic user interface).

25. A system for processing a service order comprising:
a first database for storing the service order;
a processor for formatting the service order in the first database into a web-viewable format; and
a second database for storing the service order formatted by the processor.

26. The system of claim 25, wherein the processor examines the service order in the first database for a redundancy.

27. The system of claim 25, wherein the processor examines the first database.

28. The system of claim 27, wherein the processor deletes duplicate service orders in the first database.

29. The system of claim 25, wherein the second database is a searchable web-based database.

30. A system for processing a service order comprising:
means for receiving the service order;
means for storing the service order in a first database;
means for examining the first database;
means for deleting a duplicate service order in the first database;
means for formatting the service order in the first database;
means for storing the formatted service order in a second database; and
means for accessing the formatted service order in the second database.

31. The system of claim 30, wherein the formatted service order stored in the second database is displayed with a web GUI.

32. A system for processing a service order comprising:
means for receiving a service order;
means for storing the service order in a first database;
means for examining the service order in the first database; and
means for deleting the service order if the service order is a duplicate service order.
